(19) United States
(12) Patent Application Publication
(10) Pub. No.: US 2006/0147608 A1
(43) Pub. Date: Jul. 6, 2006

(54) Method for treating cereal material with a screw transporter

(76) Inventors: Suhas K. Mehra, Miamisburg, OH (US); Eugene J. Fox, Dayton, OH (US); Aharon M. Eyal, Jerusalem (IL); Michael R. Rizor, Cedar Rapids, IA (US); Eugene M. Peters Jr, Kettering, OH (US); Donald Lee Shandera Jr, Ashland, ME (US); Ki Park, Dayton, OH (US); Rod R. Fisher, Eden Prairie, MN (US)

Correspondence Address: CARGILL, INCORPORATED, LAW/24, 15407 MCGINTY ROAD WEST, WAYZATA, MN, 55391, US

(21) Appl. No.: 10/521,050

(22) PCT Filed: Jul. 22, 2003
(86) PCT No.: PCT/US03/22965

§ 371 Date: Aug. 26, 2005

Related U.S. Application Data
(60) Provisional application No. 60/397,982, filed on Jul. 23, 2002.

(51) Int. Cl. A23K 1/00

(52) U.S. Cl. 426/623

(57) ABSTRACT

There is disclosed a method for treating a cereal with a processing solution by a screw transporter. The screw transporter is preferably a screw extruder or screw conveyer. Also disclosed is a method for using the treated cereal material as a fermentation feedstock. Further, there is disclosed a method for using the treated cereal material in the production of fermentation feedstock.

This application claims priority from U.S. Provisional Application Ser. No. 60/397,982, filed Jul. 23, 2002, the contents of which are herein incorporated by reference in its entirety.

### FIELD OF THE INVENTION

The present invention relates to a method for treating a cereal material with a processing solution by a screw transporter. The present invention also relates to a method for using the treated cereal material as a fermentation feedstock and also in the production of a fermentation feedstock.

### BACKGROUND OF THE INVENTION

Grains, including corn, oats, barley, rye, wheat, rice, and sorghum contain various concentrations of starches, proteins, fiber, and other nutrients. Often, it is desirable to process the grain to isolate various fractions or streams that are enriched in one of these components, for example, to provide a fermentation feedstock. Since these components are contained within the grain kernel, most processing methods begin with a step in which the kernel is treated to expose, separate, concentrate, isolate, or release these raw components, which may then be further refined or modified by depolymerization chemicals or enzymes.

To release the raw components of grain kernels, such as corn kernels, typically the corn is processed either by dry milling or wet milling. While dry corn milling requires a smaller operating cost and a smaller capital investment than wet milling, the cost benefits of dry milling may be offset by poor recovery of corn germ. As such, most corn processed in the United States is done by the wet milling process.

The traditional wet milling process includes steeping the corn to soften the kernels and to aid in separation of the germ, fiber, starch, and protein. During steeping, the corn absorbs the steeping solution, and the starch-protein matrix within the corn is disrupted. Typically, steeping is followed by grinding, high speed centrifugation, and/or filtration to separate corn germ, protein, fiber, and starch. The individual components (starch, protein, fiber, germ) then are separated and purified to provide product streams. These streams may be processed further or combined for any purpose such as to provide fermentation feedstocks.

The wet milling process is an energy and capital intensive process, at least partially because of the energy requirements to dehydrate excess water left unabsorbed by the corn during the steeping process. Therefore, a method that minimizes the amount of water necessary to treat the corn during steeping and that facilitates subsequent separation of various components is desirable.

### SUMMARY OF THE INVENTION

This invention relates to a method for treating a cereal material comprising treating a cereal material with a processing solution in a screw transporter and transporting the cereal material through the screw transporter(s) preferably for at least one hour, and recovering a treated cereal material. The treated cereal material of the present method may be used as is as fermentation feedstock, and may be used in the production of fermentation feedstock.

### DETAILED DESCRIPTION OF THE INVENTION

This invention relates to a method for treating a cereal material comprising treating a cereal material with a processing solution in a screw transporter and transporting the cereal material through the screw transporter(s) preferably for at least one hour, and recovering a treated cereal material. The treated cereal material of the present method may be used as is as fermentation feedstock, and may be used in the production of fermentation feedstock.

The term cereal material is defined as any cereal material or part thereof. Any cereal material, or part thereof, may be treated by the present method. The cereal material treated in the present method may include corn, oats, barley, rye, wheat, rice, and sorghum, or a mixture thereof. The cereal material may include whole kernels, or kernels that have been comminuted. In the case where a comminuted cereal material is used, it may be advantageous to size separate the comminuted cereal material to separate and remove material passing a 10 mesh screen prior to introducing the comminuted cereal material into the screw transporter.

If it is desired to pre-treat the cereal material a solvent may be used. As solvent there may be used any aqueous or organic solvent or mixture thereof. Examples of organic solvents include hexane, isohexane, ethanol, methanol, propanol, isopropanol, butanol, acetone, dimethylformamide, dimethyl sulfoxide, and the like. Preferred for use is an aqueous solvent such as water containing sulfites, preferably introduced as sulfur dioxide and/or salts of bisulfites.

Various additives may be incorporated into the solvents. For example, there may be incorporated additives that enhance the absorption of the solvent and/ or separation of cereal material into components. Further, there may be incorporated reducing agents and/ or pH adjusting agents; anti-foaming agents; wetting agents and the like. Examples of reducing agents include SO₂ and salts of sulfites and bisulfites, mercartoethanol, thioglycolic acid and the like; suitable pH adjusting agents include lactic acid, acetic acid, hydrochloric acid, sodium hydroxide, lime and the like. Further more enzymes such as cellulases, hemicellulases, proteases and the like may be utilized.

As used in the present method, a screw transporter is any device that includes (1) a screw, such as an auger; and (2) a container, such as a barrel, tube, or trough, wherein cereal material introduced into the screw transporter is transported as the screw is rotated about its axis. As such, a screw transporter includes screw extruders and screw conveyors. A screw extruder includes a screw located inside a closed chamber, except for input and discharge ports, wherein the container such as a barrel or tube encloses the screw. A screw conveyor includes a screw and an open container such as a trough, wherein the container does not completely enclose the screw.

In the present method the cereal material is treated with a processing solution. The processing solution preferably includes water or other solvent(s). Any solvent(s) may be utilized such as for example organic solvents including hexane, isohexane, ethanol, methanol, acetone, propanol, isopropanol, butanol, dimethylformamide, dimethyl sulfoxide, and the like. Preferred for use, is an aqueous solvent such as water containing sulphites. The processing solution may optionally include acid or base to control the pH of the processing solution. Any acid or base may be utilized such as sodium hydroxide, calcium hydroxide, lactic acid or the like. In addition, the processing solution may optionally contain other additives such as sulphur dioxide, typically in an amount of about 500-3000 ppm, or an enzyme(s). Suitable enzymes may include proteases, cellulases, hemicellulases, amylases, or any combination thereof.

In the present method any amount of processing solution may be used in contacting the cereal material. In a preferred embodiment the processing solution is added in an amount such that the ratio of processing solution to cereal material ranges from about 0.30 to about 0.67 m³ of processing solution per metric ton of cereal material (about 2.0 to about 4.5 gallons of processing solution per bushel of cereal material). In a further preferred embodiment of the method, the processing solution is introduced in an amount such that the cereal material will completely absorb the processing solution.

In the present method the processing solution may be introduced into the screw transporter(s) at any point. The processing solution may be introduced into the screw transporter(s) in any manner such as for example in a co-current or counter current flow in relation to the flow of the cereal material, or added at multiple locations inside the screw transporter.

The present method for treating cereal material may be carried out at any suitable temperature. In a preferred embodiment the method for treating the cereal material is carried out at a temperature ranging from about 15° C. (59° F.) to about 65° C. (149° F.).

In the present method cereal material is transported by and through the screw transporter(s). The time in which the cereal material is transported through the screw transporter(s) is preferably at least about 1 hour. In a more preferred embodiment the time for transporting the cereal material ranges from at least about 3 hours to about 10 hours.

In the present method there may be used more than one screw transporter for treating the cereal material. In this instance, between each of the individual screw transporters, the cereal material may be comminuted. The comminuting of the cereal material is carried out to an extent such that 5-90% of the germ is still recoverable as whole germ. In this embodiment, prior to comminution, water may be added to facilitate the germ release from the treated cereal material. The germ is recovered using any conventional method such as by using hydrocyclones.

The cereal material treated by the present method may be used for any applications, particularly where conventionally steeped material has been utilized. In particular the cereal material treated by the present method is expected to be useful as fermentation feedstock. Furthermore the treated cereal material is expected to be useful in the production of fermentation feedstock, such as for example for ethanol production.

An exemplary process for carrying out the wet milling of corn treated by the present method is described as follows:
Wet processing of a cereal material may be defined as processing a cereal material wherein an amount of water exceeding the amount that can be absorbed by the cereal material is used to enhance separation of the components of the cereal material. Wet processing may entail a cereal material or a product resulting from dry grinding the cereal material. The wet processing and/or the wet milling of a cereal material will provide a product comprising starch.

The steeped corn product is ground in the presence of mill process water. Grinding of the steeped corn is performed in three stages. The first stage (herewith referred to as first grind) releases most of the germ from the steeped corn using a 91 cm (36 inch) grind mill fitted with Devil's tooth ed plates operating at 900 rpm. The slurry discharge from the first grind mill is pressure feed at approximately is 6.2 bars (90 psi) through a two-pass hydrocyclone battery consisting of 15.24 cm (6 inch) hydrocyclones to separate the germ. The separated germ is washed with mill process water and dried in a rotary drum drier to yield a dried germ product. The remaining slurry from which most germ has been separated is milled again, coarsely ground using a second 91 cm (36 inch) grind mill (herewith referred as second grind) fitted with Devil's toothed plates operating at 900 rpm to detach remaining germ from ground corn in the slurry. Freed germ present in the second grind discharge slurry is separated and recovered using hydrocyclones as described above. After the removal of germ, the remaining corn material is passed over 50 micron screen (referred to as third grind dewatering screen). The filtrate containing starch-protein moves forward, while the corn material retained as overs by the screen is fine ground using a 91 cm (36 inch) grind mill (herewith referred as third grind) fitted with Devil's toothed plates operating at 1800 rpm. The fiber component in the slurry of the third grind discharge is removed by a seven stage screen separation system arranged such that the fiber is washed in a counter current flow of fiber to mill process water, where the cleanest fiber is washed with the mill process water added to the screen system. Washed fiber is discharged at the last stage (seventh stage), while starch and protein containing slurry is discharge at the first stage. The screen opening on the first fiber wash stage is 50 micron, followed by 75 micron on the second through sixth stage and 150 micron of the last stage. The washed fiber is dewatered using screw presses, and dried using a rotary drier, resulting in the dried fiber product. The discharge from the third grind dewatering screen and first stage fiber wash are combined, creating a slurry with a density of approximately 8 Baumé. This slurry is thickened with a Merco H36 centrifuge. This centrifuge operates at 2600 rpm and is fitted with No. 24 size nozzle. The overflow from the centrifuge is used as process water for steeping (also known as mill water), while the underflow slurry, having a Baumé of 12, is fed to a second H36 centrifuge (referred to as primary centrifuge). The starch-protein in the fed slurry is separated by the primary centrifuge. The primary centrifuge operates at 2200 rpm and is fitted with No. 24 nozzle to yield an underflow and overflow slurry. The overflow slurry is protein-enriched containing approximately 60% (db) protein, while the underflow slurry is starch enriched. The protein enriched overflow slurry from this centrifugation is then further dewatered by centrifugation with a third Merco H36 centrifuge operating at 2600 rpm, dewatered on a rotary drum filter and dried using a flash drier. This results in the dried protein rich product, also known as corn gluten meal. The starch enriched slurry originating from the underflow of the second Merco H36 centrifuge described above is passed through a twelve stage Dorr-Oliver clam shell hydrocyclone starch wash battery. The starch wash battery is designed such that a counter-current flow between the starch enriched stream entering the first stage of the battery and potable water entering at the twelfth stage of the battery is achieved. Each stage starch wash stage has several 10 mm hydroclones arranged in parallel fashion. Typical feed pressure to each starch wash stage, except the twelfth stage, is 6.2 bar (90 psi); the feed pressure on the twelfth stage is 8.27 (120 psi).
Purified starch with a slurry density of 23 Baumé is recovered as underflow from the twelfth stage of the starch wash battery, also known as starch slurry or starch product of corn wet milling.
Further information regarding the wet milling of corn is found in Technology of Corn Wet Milling and Associated Processes p. 69-125, Paul H. Blanchard, Elsevier Science Publishers B. V. Amsterdam.

The product of wet processing or wet milling comprising starch may be used in any conventional manner. For example, the product of wet processing or wet milling comprising starch may be used as a fermentation feedstock. In a further embodiment, the product of wet processing or wet milling comprising starch product may be processed into a fermentation feedstock.

As an example of a method for producing a fermentation feedstock, the following is provided. The starch comprising product produced by the previously described wet processing or wet milling processes may be optionally hydrolyzed to form a fermentation feedstock to be incorporated into the fermentation media. The starch slurry may be hydrolyzed to any extent to form a hydrolyzed starch, including to dextrose. The starch slurry may be hydrolyzed by any manner. For example, starch slurry may be hydrolyzed by subjecting the starch slurry to acid hydrolysis. Typically acids will include inorganic acids such as hydrochloric acid and the like. Elevated temperatures increase the rate of hydrolysis and may be varied over a wide range depending on the degree of hydrolysis desired. Acid hydrolysis is limited in the extent of starch hydrolysis possible. If one wishes to exceed that level of hydrolysis, one must use other means of hydrolysis such as enzymatic digestion of the starch with starch hydrolyzing enzymes.

An exemplary process for carrying out starch hydrolysis by acid hydrolysis is described as follows:
a) starch slurry with a 23 Baumé is provided;
b) the pH of the slurry is adjusted to 1.8 with 22 Baumé hydrochloric acid;
c) the slurry with pH 1.8 is introduced into a Dedert continuous acid conversion system (Olympia Fields, Ill., USA) at 146° C. (295° F.) for 18 minutes, after treatment in the conversion system the starch is hydrolyzed to 85 dextrose equivalents (DE); and
d) the pH of the converted starch is then adjusted to 4.8 with 10% soda ash and cooled.

An exemplary process for starch hydrolysis by enzyme/enzyme hydrolysis is described as follows:
Hydrolysis of starch is performed in the following two steps of 1) liquefaction and 2) saccharification.
   1) Liquefaction: Water is added to the starch to adjust dry solid content to 35%. The pH of slurry is adjusted to 5.5 using sodium hydroxide solution. Calcium chloride is added to the slurry to have the minimum of 5 ppm of free calcium. TERMAMYL SUPRA enzyme, (a trademarked amylase available from Novozymes North America, Inc) is added to this pH adjusted slurry at the amount of 0.4 liter per metric ton of starch dry solids. Then, the mixture is heated in a continuous jet cooker to 108° C. (226.4° F.) and held for 5 minutes in a pressurized vessel. Then the cooked mixture is cooled to 95° C. (203° F.) and held for 100 minutes. A starch hydrolyzate with a DE of 8 to 12 is produced.
   2) Saccharification: Starch hydrolyzate from the above liquefaction step is cooled to 60° C. and the dry solid content is adjusted to 32% by adding water. The pH of this diluted hydrolyzate is adjusted to 4.1-4.3 using sulfuric acid. DEXTROZYME E enzyme (a trademarked mixture of amyloglucosidase and pullunase available from Novozymes North America, Inc) is added at the amount of 0.7 liters per metric ton of dry solids and then the mixture is held for 40 hours. Dextrose content of 95-97%, on the dry solid basis, is achieved.

Further information regarding starch hydrolysis is found in Technology of Corn Wet Milling and Associated Processes p. 217-266, Paul H. Blanchard, Elsevier Science Publishers B.V. Amsterdam.

In the present invention any enzyme capable of hydrolyzing a cereal material may be used. Examples of corn hydrolyzing enzymes include starch hydrolyzing enzymes (for example amylases, pullulanases), protein hydrolyzing enzymes (for example proteases, peptidases), fiber hydrolyzing enzymes (for example cellulases, xylanases) and phytate hydrolyzing enzymes (for example phytases).

The following examples are presented to illustrate the present invention and to assist one of ordinary skill in making and using the same. The examples are not intended in any way to otherwise limit the scope of the invention.

### EXAMPLES

### Example 1

A whole grain corn is introduced into an input port or introduction end of a screw transporter. Processing solution is introduced at the discharge port or position of the screw transporter such that a counter-current flow of processing solution relative to the corn is achieved within the screw extruder. The processing solution comprises water, 2000 ppm sulphur dioxide and 0.2% (w/w) lactic acid. The processing solution is added at a ratio of about 0.45 m3 of processing solution per metric ton of the corn (3.0 gallons of processing solution per bushel of the corn) to achieve a minimum amount of unabsorbed processing solution. The time in which the corn is transported in the screw extruder is about 7 hours, and the temperature of the process is maintained at about 50° C. The corn and processing solution are passed through the transporter continuously. The resulting treated cereal material is recovered. If desired, conventional wet milling separation processes may be used for recovering germ, fiber, starch and/or protein.

### Example 2

The procedure of example 1 is followed with the following exceptions. Barley is used in place of corn as the cereal material and the processing solution is introduced such that a co-current flow relative to the barley is obtained. There is obtained treated barley. If desired fiber, starch and/or protein may be separated using conventional wet milling separation processes.

### Example 3

The procedure of example 1 is followed with the following exception. The processing solution comprises sodium hydroxide instead of both sulphur dioxide and lactic acid. The resulting treated cereal material is separated and recovered.

### Example 4

The procedure of example 1 is followed with the following exceptions. In place of a single screw transporter there are utilized three screw transporters in succession. Between each of the three screw transporters there are employed 91 cm (36 inch) disk mills wherein the corn commuted the corn.

### Example 5

The procedure of example 1 is followed with the following exception. In place of the processing solution used in example 1, there is used a processing solution comprising of water and 5% w/w thioglycolic acid.

### Example 6

The procedure of example 1 is followed with the following exception. In place of whole corn, ground corn pieces of size greater than 10 Mesh are used.

The invention has been described with references to various specific and illustrative embodiments and techniques. However, one skilled in art will recognize that the many variations and modifications may be made while remaining within the sprit and scope of the invention.

1. A method for treating a cereal material comprising;
treating a cereal material with a processing solution in a screw transporters; transporting the cereal material through the screw transporter(s); and
separating at least one component from the cereal material wherein the components are selected from the group consisting of germ, fiber, protein and starch.

2. The method according to claim 1 wherein the cereal material is selected from the group consisting of corn, oats, barley, rye, wheat, rice, sorghum and mixtures thereof.

3. The method according to claim 1, wherein the screw transporter is selected from the group consisting of a screw extruder and a screw conveyer.

4. The method according to claim 1 wherein the cereal material comprises absorbed solvent selected from the group consisting of an aqueous solvent, an organic solvent and mixtures thereof.

5. The method according to claim 4 wherein the aqueous solvent is water.

6. The method according to claim 4 wherein the solvent comprises at least one compound selected from the group consisting of wetting agents, reducing agents and pH modifiers.

7. The method according to claim 1 wherein the processing solution comprises an acid and sulphur dioxide.

8. The method according to claim 7 wherein the acid is lactic acid.

9. The method according to claim 1 wherein the cereal material is treated with processing solution for a period of at least 1 hour.

10. The method according to claim 1 wherein the cereal material is treated with processing solution for a period of at least 3 hours.

11. The method according to claim 1 wherein the temperature ranges from about 15° C. to about 65° C.

12. The method according to claim 1 wherein the processing solution is present in an amount ranging from about 0.30 to about 0.67 m³ of processing solution per metric ton of cereal material (about 2.0 to about 4.5 gallons of processing solution per bushel of cereal material).

13. The method according to claim 12 wherein the processing solution is present in an amount that will be completely absorbed by the cereal material.

14. The method according to claim 1 wherein more than one screw transporter is utilized.

15. The method according to claim 14 wherein discharge from the screw transporter is comminuted.

16. (canceled)

17. The method according to claim 16 wherein the starch containing stream is hydrolyzed.

18. A method for producing a fermentation feedstock comprising using the starch containing stream produced in accordance with claim 16.

19. A method for producing a fermentation feedstock comprising using the hydrolyzed starch containing stream produced in accordance with claim 17.

20. A method for using the starch containing stream product of claim 16 as fermentation feedstock.

21. A method for using the hydrolyzed starch containing stream of claim 17 as fermentation feedstock.
